(19) United States
(12) Patent Application Publication
(10) Pub. No.: US 2023/0059648 A1
(43) Pub. Date: Feb. 23, 2023

(54) AUXILIARY PHOTOGRAPHIC APPLIANCE AND METHOD FOR USING SAME

(71) Applicant: BACKSCATTER, Guangdong (CN)

(72) Inventor: James Edward DECKER, Monterey, CA (US)

(21) Appl. No.: 17/776,192

(22) PCT Filed: Nov. 12, 2019
(86) PCT No.: PCT/CN2019/117564

§ 371 Date: Oct. 26, 2022

(51) Int. Cl. G03B 15/07

(52) U.S. Cl. CPC G03B 15/07

(57) ABSTRACT

Disclosed is an auxiliary photographic equipment, comprising a light-emitting assembly (10), a snoot assembly (20) and a light-shielding piece (30), wherein the light-emitting assembly (10) is provided with a light-emitting area (11) in which an illuminating lamp (12) is mounted; the snoot assembly (20) comprises a snoot (21) and a lens module (22), the snoot (21) is provided with an incident end (21a) and an emergent end (21b), the incident end (21a) of the snoot (21) is connected to the light-emitting assembly (10) and covers the light-emitting area (11), the lens module (22) is mounted in the snoot (21) and located between the incident end (21a) and the emergent end (21b), and the lens module (22) is configured to organize light rays from the incident end (21a) and then emit the light rays through the emergent end (21b) to form a light spot (40); and the light-shielding piece (30) is plugged on the snoot (21), and the light-shielding piece (30) is provided with an auxiliary light-transmitting hole (31) for adjusting the shape of the light spot (40) so as to assist a photographer in obtaining the light spot (40) of different shapes.

### TECHNICAL FIELD

This application relates to the technical field of photographic equipment, and in particular to an auxiliary photographic equipment and a method for using the same.

### BACKGROUND ART

A modeling lamp is used to turn on the light before shooting such that the light shines on the subject, and the photographer can adjust the angle and effect of the light hitting the subject. When the modeling lamp is used, an auxiliary function of a snoot is generally taken advantage of, to allow the light to output toward a certain direction and range, that is, to make a light spot with a clear illumination range. However, the shape of the light spot is relatively fixed, which is generally similar to the shape of the snoot outlet. It can not be flexibly changed during shooting and is inconvenient for use.

### SUMMARY OF THE INVENTION

### Technical Problem

One of the objectives of examples of this application is to provide an auxiliary photographic equipment and a method for using the same, aiming at solving the problem that the shape of the light spot produced by the snoot is relatively fixed and cannot be flexibly changed during shooting.

### Solution to the Problem

### Technical Solution

To solve the above technical problem, the a technical solution adopted in the examples of this application is as follows.

In a first aspect, an auxiliary photographic equipment is provided, which comprises a light-emitting assembly, a snoot assembly and a light-shielding piece, where the light-emitting assembly is provided with a light-emitting area in which an illuminating lamp is mounted; the snoot assembly comprises a snoot and a lens module, the snoot is provided with an incident end and an emergent end, the incident end of the snoot is connected to the light-emitting assembly and covers the light-emitting area, the lens module is mounted in the snoot and located between the incident end and the emergent end, and the lens module is configured to organize light rays from the incident end and then emit the light rays through the emergent end to form a light spot; and the light-shielding piece is detachably plugged on the snoot, and the light-shielding piece is provided with at least one auxiliary light-transmitting hole for adjusting the shape of the light spot.

In a second aspect, a method for using the auxiliary photographic equipment is provided, which comprises the following steps:

S001: providing a light-emitting assembly, a snoot assembly and a light-shielding piece, rotatably mounting the snoot on the light-emitting assembly, and plugging the light-shielding piece on the snoot;

S002: turning on an illuminating lamp located in the light-emitting area such that the light enters the snoot, and after organizing the light through the lens module and the auxiliary light-transmitting hole, emitting the light from the emergent end and forming a light spot; and

S003: tilting the snoot by a certain angle and allowing the emergent end to face toward the target, and/or rotating the snoot by 0° to 90° to adjust the shape of the light spot projected on the target.

### Beneficial Effects of the Invention

### BRIEF DESCRIPTION OF THE DRAWINGS

### DESCRIPTION OF THE DRAWINGS

In order to more clearly describe the technical solution in the examples of this application, the drawings needed in the examples or exemplary technical descriptions will be briefly introduced below. Obviously, the drawings in the following description are only some examples of this application, and those of ordinary skill in the art can also obtain other drawings based on these drawings without paying creative labor.

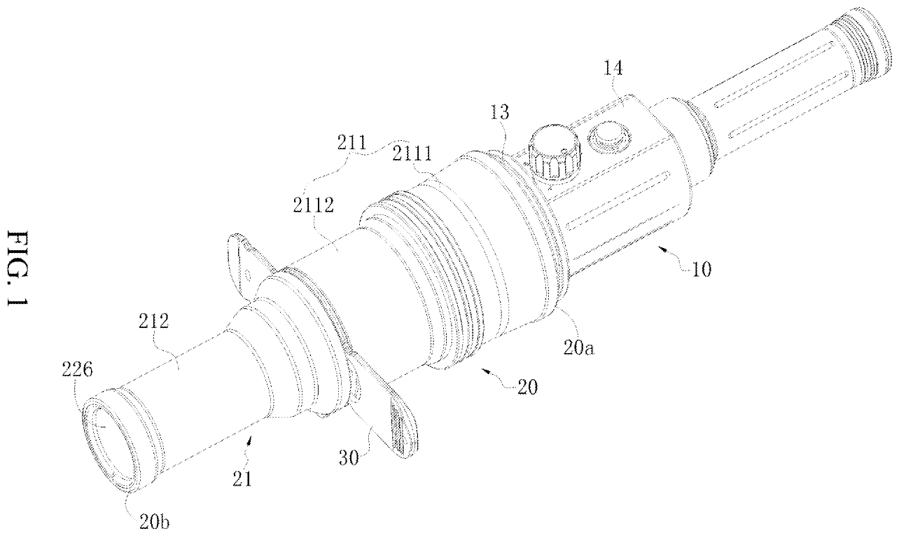

FIG. 1 is a schematic structural diagram of the auxiliary photographic equipment provided by the examples of this application;

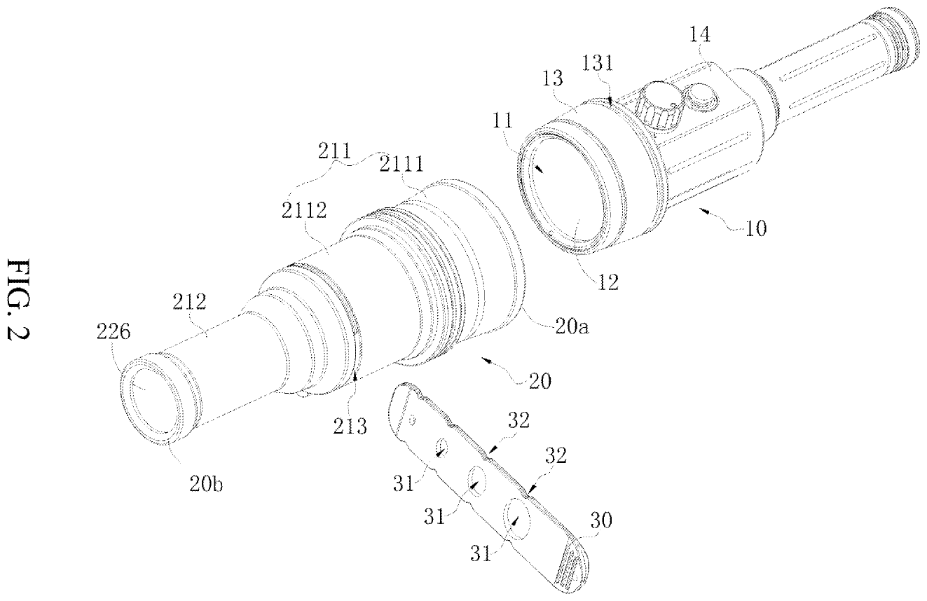

FIG. 2 is a schematic diagram of the explosive structure of the auxiliary photographic equipment in FIG. 1;

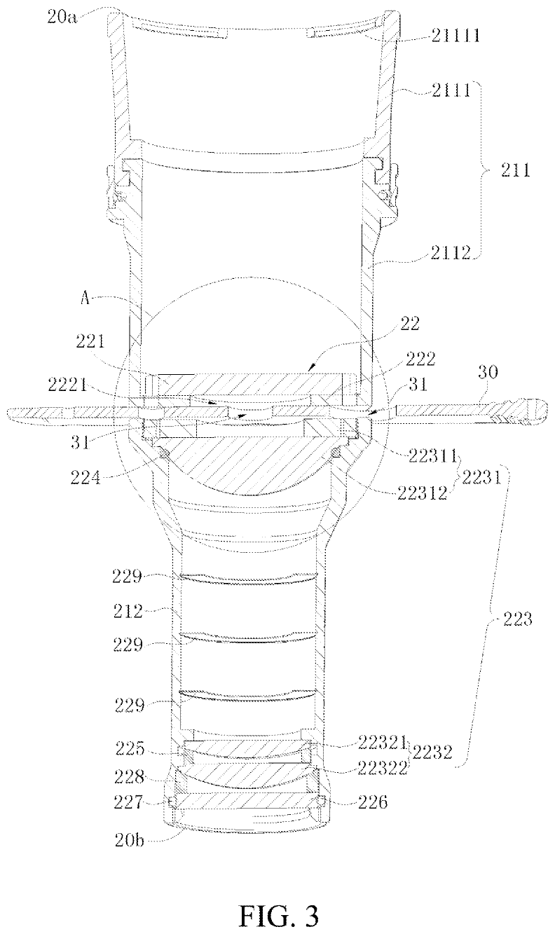

FIG. 3 is a schematic structural diagram of a part of a section of the auxiliary photographic equipment in FIG. 1;

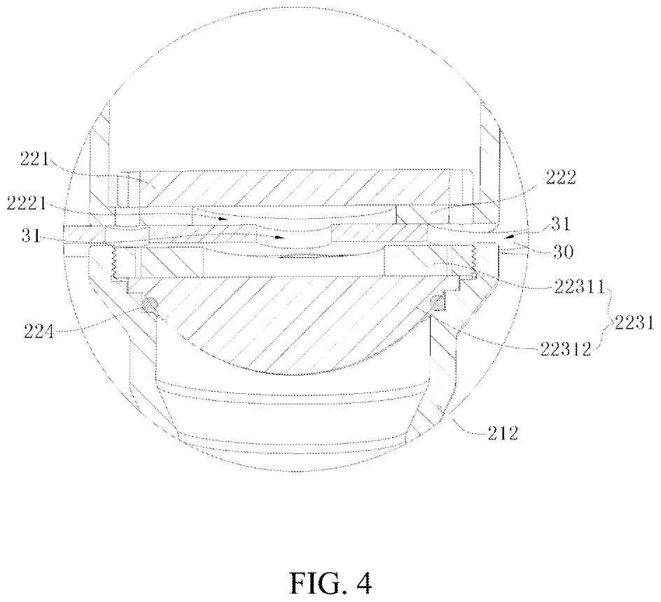

FIG. 4 is a partially enlarged structural schematic diagram of A in FIG. 3;

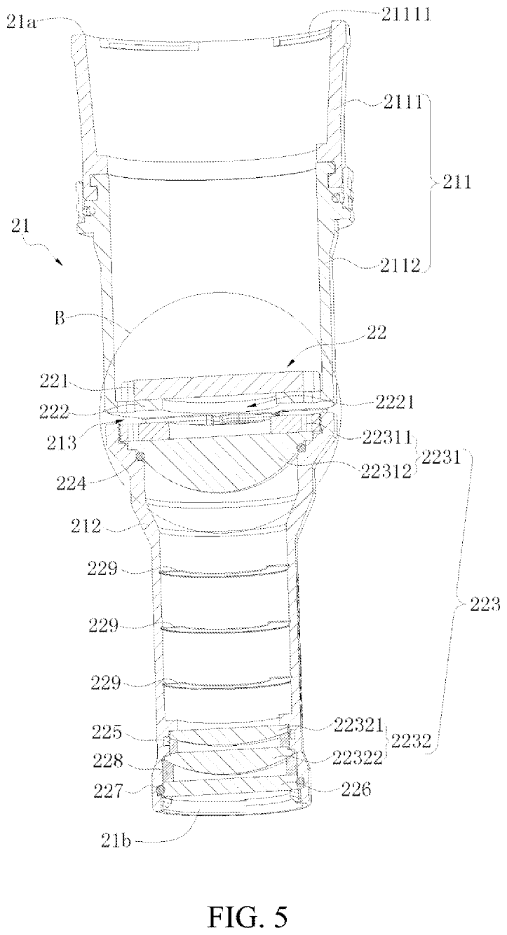

FIG. 5 is a schematic structural diagram of a section of the snoot assembly of the auxiliary photographic equipment in FIG. 1;

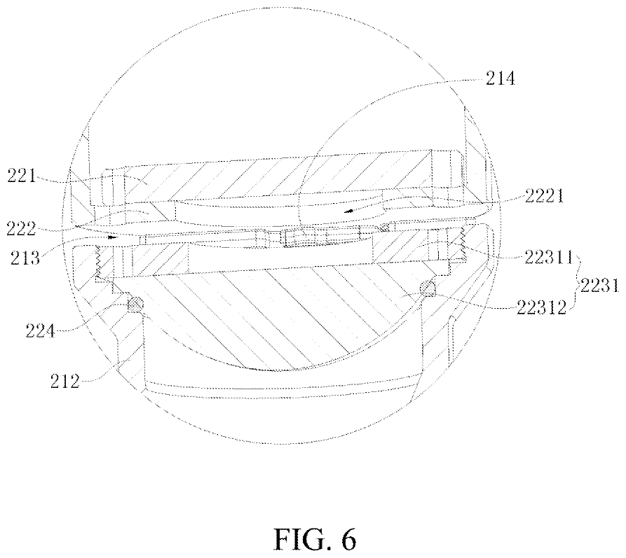

FIG. 6 is a partially enlarged structural schematic diagram of B in FIG. 5:

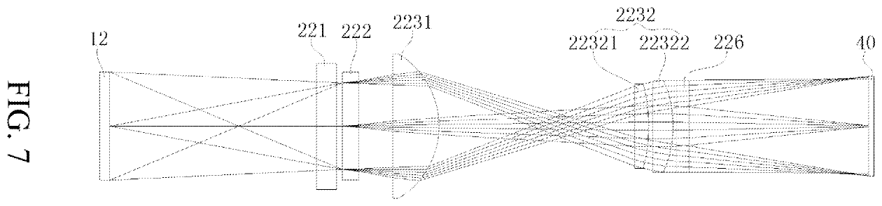

FIG. 7 is a schematic diagram of the optical path in the auxiliary photographic equipment of FIG. 1;

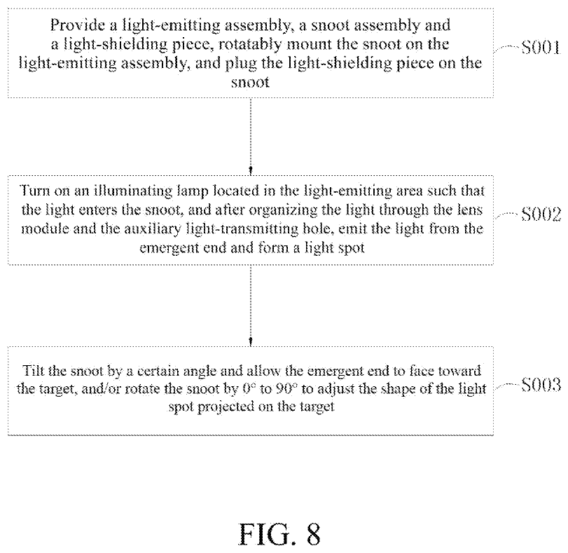

FIG. 8 is a step diagram of the method for using the auxiliary photographic equipment provided in another example of this application;

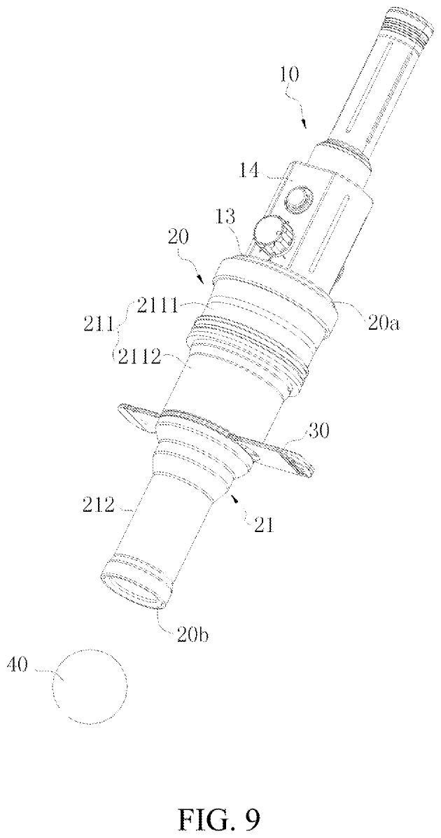

FIG. 9 is a state diagram 1 of the method for using the auxiliary photographic equipment provided in another example of the present application; and

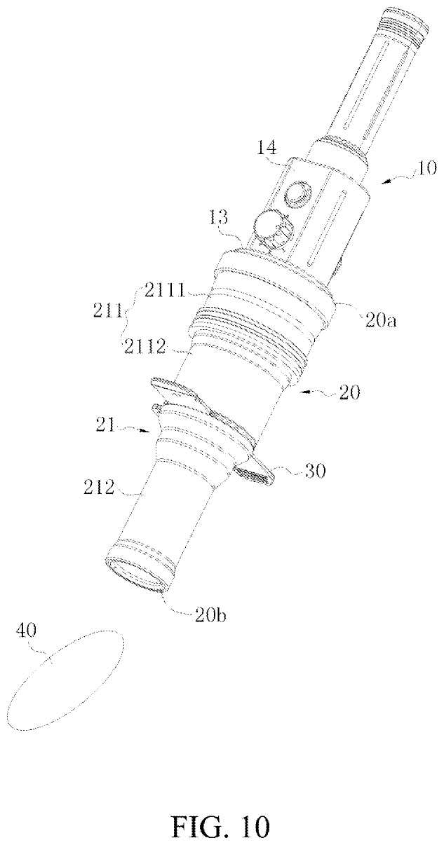

FIG. 10 is a state diagram 2 of the method for using the auxiliary photographic equipment provided in another example of the present application.

### Examples of the Invention

### DETAILED DESCRIPTION

In order to make the objective, technical solution and advantages of this application more clear, this application is further described in detail below in combination with the drawings and examples. It should be understood that, the specific examples described herein are only used to explain this invention and not to define this application.

It should be noted that, when a component is referred to as “fixed to” or “set to” another component, it can be directly or indirectly on another component. When a component is referred to as “connected to” another component, it can be directly or indirectly connected to the another component. The orientational or positional relationship indicated by the terms “upper,” “lower,” “left,” “right” and the like is based on the orientational or positional relationship shown in the drawings, and is only for the convenience of description, rather than indicating or implying that the indicated device or element must have a specific orientation, or be constructed and operated in a specific orientation. Therefore, it should not be understood as a limitation to this application. For those of skill in the art, the specific meaning of the above terms can be understood according to the specific situation. The terms “first” and “second” are only used for descriptive purposes, and should not be understood as indicating or implying relative importance or implicitly indicating the number of indicated technical features. “Multiple” means two or more, unless otherwise specified particularly.

In order to explain the technical solution described in this application, the following is a detailed description in combination with the specific drawings and examples.

As shown in FIGS. 1, 2, 3 and 7, some examples of this application provide an auxiliary photographic equipment, comprising a light-emitting assembly 10, a snoot assembly 20 and a light-shielding piece 30, wherein the light-emitting assembly 10 is provided with a light-emitting area 11 in which an illuminating lamp 12 is mounted; the snoot assembly 20 comprises a snoot 21 and a lens module 22, the snoot 21 is provided with an incident end 21a and an emergent end 21b, the incident end 21a of the snoot 21 is connected to the light-emitting assembly 10 and covers the light-emitting area 11, the lens module 22 is mounted in the snoot 21 and located between the incident end 21a and the emergent end 21b, and the lens module 22 is configured to organize light rays from the incident end 21a and then emit the light rays through the emergent end 21b to form a light spot 40; and the light-shielding piece 30 is detachably plugged on the snoot 21, and the light-shielding piece 30 is provided with at least one auxiliary light-transmitting hole 31 for adjusting the shape of the light spot 40.

In the use of the auxiliary photographic equipment provided by some examples of this application, after the light emitted from the light-emitting area 11 enters the snoot 21 from the incident end 21a, the lens module 22 and the light-shielding piece 30 located in the snoot 21 jointly organize the light such that the shape of the light spot 40 formed by the light emitted from the emergent end 21b is the same as that of the auxiliary light-transmitting hole 31. Since the light-shielding piece 30 is detachable from the snoot 21, the photographer can prepare the light-shielding piece 30 with a variety of auxiliary light-transmitting holes 31 of different shapes or set the auxiliary light-transmitting holes 31 of different shapes and sizes on one light-shielding piece 30 in advance so that during shooting the photographer can change the auxiliary light-transmitting holes 31 of different shapes as needed to project the light spot 40 of different shapes for shooting, which is convenient for use.

In one example, as shown in FIGS. 1, 2, 3 and 7, the light-shielding piece 30 is in a shape of a long strip, and a plurality of auxiliary light-transmitting holes 31 are provided. Each of the auxiliary light-transmitting holes 31 extends along the length direction of the light-shielding piece 30. In particular, when in use, by allowing the length direction of the light-shielding piece 30 to be perpendicular to the central axis of the snoot 21, and the light-shielding piece 30 to be able to move on the snoot 21 in a direction perpendicular to the central axis, the auxiliary light-transmitting holes 31 at different positions on the light-shielding piece 30 are changed to be located in the snoot 21 so as to limit the part of the light emitted from the emergent end 21b, thereby to achieve the purpose of using one light-shielding piece 30 to adjust the emission of different light spots 40, and the use is convenient.

In one example, the auxiliary light-transmitting hole 31 is centrosymmetric. Specifically, by setting the auxiliary light-transmitting hole 31 as a centrosymmetric figure, it is convenient for the photographer to locate and shoot, and the use effect is good. Where, the photographer can set the shape of the auxiliary light-transmitting hole 31 as a circle, an ellipse, a triangle, a rectangle, a diamond, a pentagram, a heart, a four-leaf clover or other specific shapes according to the needs in shooting of the object, and this is convenient and flexible to use.

In one example, as shown in FIGS. 3 to 5, the lens module 22 comprises a projection lens 221 and an optical lens module 223, where the projection lens 221 is mounted on the snoot 21, and is used to diffuse the light emitted from the incident end 21a; and the optical lens module 223 is mounted in the snoot 21 and is located between the projection lens 221 and the emergent end 21b. The light-shielding piece 30 is provided attaching to the projection lens 221 and the light-shielding piece 30 is located on a side of the projection lens 221 facing towards the emergent end 21b. The optical lens module 223 is used to converge and shape the light passing through the auxiliary light-transmitting hole 31, and then the light is emitted from the emergent end 21b. Specifically, when the lens module 22 organizes the light from the incident end 21a, the light enters the snoot 21 and then first shoots at the projection lens 221. At this moment, the light diffuses on the projection lens 221 to uniformly illuminate the projection lens 221 so that the light from different directions can be all organized and blended on the projection lens 221. Since the light-shielding piece 30 is provided attaching to the side of the projection lens 221 facing towards the emergent end 21b, and the light on the projection lens 221 can only pass through the auxiliary light-transmitting hole 31 on the light-shielding piece 30, the auxiliary light-transmitting hole 31 on the light-shielding piece 30 determines the shape of the light spot 40 projected on the projection lens 221. After the light passes through the auxiliary light-transmitting hole 31, it is further organized through the optical lens module 223 to ensure the brightness and shape of the light spot 40 composed of each light. The light is finally emitted from the emergent end 21b. Since the light spot 40 is projected by the projection lens 221 through the auxiliary light-transmitting hole 31, the brightness of the light spot 40 is the same and uniform as that on the projection lens 221, and the shape of the light spot 40 is the same as that of the auxiliary light-transmitting hole 31. Thus, the user can control the shape of the light spot 40 according to the shooting needs, to obtain an ideal light spot 40 with a clear boundary, and the effect in use is good.

Where, the projection lens 221 may be a semi-transparent object such as frosted glass or a diffusion plate to diffuse and pass the light.

In one example, as shown in FIGS. 3 to 5, the lens module 22 further comprises a light-shielding ring 222 which is provided attaching to the projection lens 221, is located between the projection lens 221 and the light-shielding piece 30, and is provided with at least one light-transmitting hole for projection. A cross section of the light-transmitting hole 2221 is greater than or equal to a cross section of the auxiliary light-transmitting hole 31. Specifically, the light-shielding ring 222 is fixedly connected with the projection lens 221. For example, the light-shielding ring 222 can be attached to the periphery of the projection lens 221 through a double-sided adhesive tape. Since the light-shielding ring 222 is located between the projection lens 221 and the light-shielding piece 30, after the light hits the projection lens 221, the light first passes through the light-shielding ring 222. At this moment, the light-shielding ring 222 blocks part of the light, thereby forming a light spot 40 with the same shape as the light-transmitting hole 2221 on the light-shielding ring 222, which hits the light-shielding piece 30. Then, the light spot 40 formed by the light is blocked by the light-shielding piece 30, and once again, a light spot 40 with the same shape as the auxiliary light-transmitting hole 31 is obtained to hit the lens module 22. Subsequently, the light spot 40 is finally projected out under the organizing and focusing of the lens module 22 such that the photographer can obtain a light spot 40 with the same shape as the auxiliary light-transmitting hole 31 and uniform brightness. Also, the photographer can also, as needed, obtain a light spot 40 with the same shape as the light-transmitting hole 2221 for use by directly taking advantage of the light-shielding ring 222 instead of the light-shielding piece 30 when taking photos, and this is flexible and convenient.

In one example, the light-transmitting hole 2221 is centrosymmetric, and the symmetric center of the light-transmitting hole 2221 and the symmetric center of the auxiliary light-transmitting hole 31 are both located on the central axis of the snoot 21, which can facilitate the positioning and shooting by the photographer, and the effect in use is good. Where, the photographer can set the shape of the light-transmitting hole 2221 as a circle, an ellipse, a triangle, a rectangle, a diamond, a pentagram, a heart, a four-leaf clover or other specific shapes according to the needs in shooting of the object, and this is convenient and flexible to use.

In one example, as shown in FIGS. 3 and 5, the optical lens module 223 comprises a condensing lens 2231 and a beam shaping lens set 2232. The condensing lens 2231 is mounted on the snoot 21 and provided close to the light-shielding ring 222. The beam shaping lens set 2232 is mounted on the snoot 21 and provided close to the emergent end 21b. Specifically, after the light passes through the light-transmitting hole 2221 and/or the auxiliary light-transmitting hole 31, the condensing lens 2231 first converges and focuses the light to ensure the brightness of the light spot 40, and then the light is organized into the shape of the light-transmitting hole 2221 or the auxiliary light-transmitting hole 31 through the beam shaping lens set 2232 and emitted from the emergent end 21b, thereby ensuring that the projected light spot 40 is the same shape as the light-transmitting hole 2221.

In one example, as shown in FIG. 6, the condensing lens 2231 comprises an annular mounting part 22311 and a condensing part 22312, where the annular mounting part 22311 is provided attaching to the periphery of the condensing part 22312 and mounted on the snoot 21, and the condensing part 22312 is located on a side of the annular mounting part 22311 facing toward the beam shaping lens set 2232. Specifically, the condensing part 22312 is a convex lens. During mounting of the condensing lens 2231, the condensing part 22312 for converging light is first mounted on the annular mounting part 22311, then an internal thread is set on an inner wall of the snoot 21, and an external thread is set on the periphery of the annular mounting part 22311, and the annular mounting part 22311 is connected with the snoot 21, which can facilitate the mounting and removal of the condensing lens 2231, and facilitate the use. Where, the annular mounting part 22311 can be bonded to the periphery of the condensing part 22312 by double-sided glue so that the center of the annular mounting part 22311 is on the central axis of the condensing part 22312, thereby ensuring the focusing effect of light on the condensing part 22312.

In one example, as shown in FIG. 6, an annular washer 224 is provided between the condensing part 22312 and the snoot 21. Specifically, by providing an annular washer 224 between the condensing part 22312 and the snoot 21, and making the annular washer 224 in an extruded state, the condensing part 22312 can be better supported by the snoot 21, and the mounting of the condensing part 22312 is more stable; and additionally, the condensing part 22312 can also be well protected so that there is certain buffering between the condensing part 22312 and the inner wall of the snoot 21 such that even if the snoot 21 is accidentally dropped, since the condensing part 22312 and the inner wall of the snoot 21 are not in rigid contact, the condensing part 22312 can be effectively protected under the action of the annular gasket despite the external impact force, reducing the risk of the fragmentation of the condensing part 22312.

In one example, as shown in FIGS. 3 and 5, the beam shaping lens set 2232 comprises a first shaping lens 22321 and a second shaping lens 22322. The first shaping lens 22321 and the second shaping lens 22322 are mounted side by side on the snoot 21, and the second shaping lens 22322 is provided close to a side of the first shaping lens 22321 facing toward the emergent end 21b. Specifically, both the first shaping lens 22321 and the second shaping lens 22322 are convex lenses. The first shaping lens 22321 and the second shaping lens 22322 together shape the light acted by the condensing lens 2231 so that various light rays are combined to form a light spot 40 of the same shape as the light-transmitting hole 2221 or the auxiliary light-transmitting hole 31.

In one example, as shown in FIGS. 3 and 5, a first annular support 225 is provided between the first shaping lens 22321 and the second shaping lens 22322 such that there is a certain gap between the first shaping lens 22321 and the second shaping lens 22322, so as to avoid the abrasion caused by mutual contact between the first shaping lens 22321 and the second shaping lens 22322, which affects the light shaping effect. In addition, the first annular support 225 can also allow the first shaping lens 22321 and the second shaping lens 22322 to be mounted more stably relative to each other, prevent looseness, and ensure the light shaping effect, namely, ensure that the shape of the light spot 40 will not be distorted.

In one example, as shown in FIGS. 3 and 5, the snoot assembly 20 further comprises a protective lens 226, which is mounted on the snoot 21 and located between the emergent end 21b and the second shaping lens 22322. The protective lens 226 is used to prevent foreign matters from entering the snoot 21 through the emergent end 21b. Specifically, the protective lens 226 is provided at the outermost end to protect the beam shaping lens set 2232 and prevent the second shaping lens 22322 from being scratched by foreign matters; or to prevent foreign moisture from entering the snoot 21 through the emergent end 21b and distorting the light shaped by the beam shaping lens set 2232, so as to ensure the stability of the shape of the light spot 40. Where, a sealing ring 227 is provided between the periphery of the protective lens 226 and the snoot 21 to ensure the sealing effect.

In one example, as shown in FIGS. 3 and 5, a second annular support 228 is provided between the protective lens 226 and the second shaping lens 22322 such that there is a certain gap between the protective lens 226 and the second shaping lens 22322, so as to avoid the abrasion caused by the mutual contact between the protective lens 226 and the second shaping lens 22322, which affects the effect of light shaping by the second shaping lens 22322. In addition, the second annular support 228 can also allow the second shaping lens 22322 to be mounted more stably, prevent looseness, and ensure the light shaping effect, namely, ensure that the shape of the light spot 40 will not be distorted.

In one example, as shown in FIGS. 3 and 5, at least one annular anti-reflection piece 229 is provided between the condensing lens 2231 and the beam shaping lens set 2232 to reflect light rays incident toward an inner wall of the snoot 21. Specifically, when the light passes through the condensing part 22312 and shoots at the beam shaping lens set 2232, a main optical path formed by most of the light rays together passes through the middle of the annular anti-reflection piece 229, and part of the light rays shoot at the inner wall of the snoot 21. The annular anti-reflection piece 229 provided on the inner wall of the snoot 21 absorbs the light rays shooting at the inner wall of the snoot 21, so as to prevent the light rays shooting at the inner wall of the snoot 21 from reflecting, and effectively prevent the phenomenon that the boundary of the light spot 40 is not clear due to the free reflection of the light rays directed at the inner wall of the snoot 21 until the light rays shoot out of the emergent end 21b, and the effect in use is good.

In one example, as shown in FIGS. 3 and 5, the inner wall of the snoot 21 is provided with an annular slot (not shown), and the periphery of the annular anti-reflection piece 229 is clamped in the annular slot. Specifically, during mounting of the annular anti-reflection piece 229, the annular anti-reflection piece 229 is clamped in the annular slot by providing the annular slot on the inner wall of the snoot 21. In this way, the annular anti-reflection piece 229 can be stably mounted in the snoot 21 to prevent relative sliding between the annular slot and the inner wall of the snoot 21, and ensure the anti-reflection effect of the annular anti-reflection piece 229.

In one example, as shown in FIGS. 3 and 5, the annular anti-reflection piece 229 is perpendicular to the inner wall of the snoot 21 when mounted in the snoot 21 such that a better anti-reflection effect, that is, an effect of blocking light can be achieved.

In one example, the annular anti-reflection piece 229 is a black sheet. Specifically, the annular anti-reflection piece 229 is made of a black sheet, such as a black film or a stainless steel sheet with a black coating. Namely, the light rays are absorbed by taking advantage of the good anti-reflection effect of the black sheet. Next, the black sheet has certain elasticity and structural rigidity, making it not only easy to mount in the annular slot, but also able to ensure that the annular anti-reflection piece 229 mounted in the annular slot has sufficient structural strength to keep perpendicular to the inner wall of the snoot 21 so as to block the light.

In one example, as shown in FIGS. 3 and 5, a plurality of annular anti-reflection pieces 229 can be provided as needed. Each annular anti-reflection piece 229 is provided side by side along the length direction of the snoot 21, and the center of each annular anti-reflection piece 229 is on the central axis of the snoot 21 such that each annular anti-reflection piece 229 can absorb light rays shooting toward the inner wall of the snoot 21 at different positions of the snoot 21, ensuring a clear boundary of the light spot 40.

In one example, as shown in FIGS. 1 to 2, the light-emitting assembly 10 is provided with a socket 13, the light-emitting area 11 is located at the end of the socket 13, and the snoot 21 is sleeved with the socket 13. Specifically, the center of the light-emitting area 11 is located on the central axis of the socket 13. During mounting, the photographer socks the incident end 21a of the snoot 21 on the socket 13 such that the central axis of the snoot 21 and the central axis of the socket 13 are in the same line, ensuring that the light emitted by the light-emitting area 11 can well shoot into the snoot 21, and reducing the loss of light. The photographer can use the snoot 21 to constrain the light emitted by the illuminating lamp 12 to obtain the light spot 40 of the target shape. In addition, by connecting the snoot 21 with the socket 13 in a socket manner, it is also easy to mount and remove the snoot 21, and the use is convenient. Where, the light-emitting assembly 10 comprises a holding body 14 and a power supply unit mounted on the holding body 14, the socket 13 is provided on the holding body 14, and the illuminating lamp 12 is mounted on the socket 13 and electrically connected with the power supply unit.

In one example, as shown in FIGS. 2 to 3, the snoot 21 comprises a light incident cylindrical sleeve 211 and a light projection cylindrical sleeve 212 mounted at one end of the light incident cylindrical sleeve 211, the light incident cylindrical sleeve 211 is sleeved with the socket 13, the incident end 21a is located at one end of the light incident cylindrical sleeve 211 away from the light projection cylindrical sleeve 212, the emergent end 21b is located at one end of the light projection cylindrical sleeve 212 away from the light incident cylindrical sleeve 211, and the projection lens 221, the light-shielding piece 30 and the optical lens module 223 are all mounted on the light projection cylindrical sleeve 212. Specifically, the central axis of the light incident cylindrical sleeve 211 and the central axis of the light projection cylindrical sleeve 212 are on the same line. When the snoot 21 is mounted on the socket 13, the light incident cylindrical sleeve 211 and the socket 13 can be mounted detachably. After mounting, the light of the light-emitting area 11 is input from the light incident cylindrical sleeve 211 and then processed by each optical component in the light projection cylindrical sleeve 212, and a light spot 40 of a target shape with a clear boundary is projected for the photographer to use.

In one example, as shown in FIGS. 2 to 3, the light incident cylindrical sleeve 211 comprises a mounting cylindrical sleeve 2111, one end of the mounting cylindrical sleeve 2111 is connected with the light projection cylindrical sleeve 212, and the other end of the mounting cylindrical sleeve 2111 is sleeved with the socket 13. Specifically, the cross sections of the mounting cylindrical sleeve 2111 and the socket 13 are both circular. When the snoot 21 is mounted on the socket 13, it is firmly sleeved on the periphery of the socket 13 by the mounting cylindrical sleeve 2111 such that the snoot 21 will not shake randomly with respect to the socket 13, and the effect in use is good. Where, the mounting cylindrical sleeve 2111 may be an annular rubber cylindrical sleeve, which can make use of certain elasticity of the rubber so that the mounting cylindrical sleeve 2111 can not only be sleeved tightly on the socket 13, but also be easily detachable, and also the snoot 21 can rotate relative to the socket 13, which is convenient for use.

In one example, as shown in FIGS. 2 to 3, the socket 13 is provided with an annular positioning slot 131, and the mounting cylindrical sleeve 2111 is provided with at least one arc positioning body 21111 which is clamped with the annular positioning slot 131. Specifically, by providing an annular positioning slot 131 on the socket 13, when the mounting cylindrical sleeve 2111 is sleeved on the socket 13, the arc positioning body 21111 is clamped into the annular positioning slot 131 by continuously pushing the mounting cylindrical sleeve 2111, so as to complete the mounting of the snoot 21. Where, the annular positioning slot 131 is a slot in a plane, and the diameter of the annular positioning slot 131 is made perpendicular to the central axis of the socket 13 such that after the arc positioning body 21111 is clamped into the annular positioning slot 131, the auxiliary positioning function of the arc positioning body 21111 can be taken advantage of to make the central axis of the snoot 21 always be on the same line as the central axis of the socket 13 when the snoot 21 rotates relative to the socket 13, thereby ensuring that the light is not lost when the snoot 21 rotates. Moreover, since the arc positioning body 21111 and the annular positioning slot 131 clamp with each other, the connection between the mounting cylindrical sleeve 2111 and the socket 13 is more stable, to prevent the snoot assembly 20 from tilting or shaking due to its own weight with respect to the light emitting assembly 10, and ensure that the central axis of the snoot assembly 20 and the central axis of the light emitting assembly 10 are on the same line, and the effect in use is good.

In one example, as shown in FIGS. 2 to 3, the light incident cylindrical sleeve 211 further comprises a light transition cylindrical sleeve 2112 which is mounted between the mounting cylindrical sleeve 2111 and the light projection cylindrical sleeve 212. Specifically, the light transition cylindrical sleeve 2112 can be set to a certain length as required such that the light emitted from the light-emitting area 11 can be blended over a certain distance, and thus the light can be mixed more uniformly when it shines on the projection lens 221. Namely the light at each position of the projection lens 221 is more uniform, and thereby the brightness of the obtained light spot 40 is more uniform. In addition, when a plurality of illuminating lamps 12 emit light toward the projection lens 221 at the same time, a phenomenon that the light spot 40 projected through the snoot 21 is non-uniform occurs because light spots 40 of the plurality of illuminating lamps 12 appear.

In one example, as shown in FIGS. 2 to 4, the snoot 21 is provided with a plug slot 213 that runs through the opposite sides of the snoot 21. The plug slot 213 is provided close to the light-shielding ring 222 and is located at one side of the light-shielding ring 222 facing toward the emergent end 21b. The light-shielding piece 30 is plugged in the plug slot 213. Specifically, by providing the plug slot 213 on the snoot 21, the light-shielding piece 30 can be mounted detachably on the snoot 21 through the plug slot 213, which is very convenient for use.

In one example, as shown in FIGS. 2 and 6, a side wall of the plug slot 213 is provided with a positioning protrusion 214 or a positioning slot 32 for positioning together with the light-shielding piece 30. Correspondingly, the light-shielding piece 30 is provided with a positioning slot 32 or a positioning protrusion 214 for positioning together with a side wall of the plug slot 213. Specifically, when the light-shielding piece 30 is plugged into the plug slot 213, it is positioned by the positioning protrusion 214 or the positioning slot 32 provided between the light-shielding piece 30 and the side wall of the plug slot 213 so that it is easy for the photographer to identify that the light-shielding piece 30 is plugged into the designated position for shooting, and it is convenient for use.

As shown in FIGS. 1, 8, 9 and 10, some examples of this application further provide a method for using the above auxiliary photographic equipment, comprising the following steps:

S001: providing a light-emitting assembly 10, a snoot assembly 20 and a light-shielding piece 30, rotatably mounting a snoot 21 on the light-emitting assembly 10, and plugging the light-shielding piece 30 on the snoot 21;

S002: turning on an illuminating lamp 12 located in the light-emitting area 11 such that the light shoots into the snoot 21, and after organizing the light through the lens module 22 and the auxiliary light-transmitting hole 31, emitting the light from the emergent end 21b and forming a light spot 40; and

S003: tilting the snoot 21 by a certain angle and allowing the emergent end 21b to face toward the target, and/or rotating the snoot by 210° to 90° to adjust the shape of the light spot 40 projected on the target.

As for the method for using the auxiliary photographic equipment provided by some examples of this application, during the use, the photographer can change the shape of the light spot 40 projected on the horizontal plane by tilting the snoot 21 according to the shape needs of the object to be shot; or rotate the snoot 21 when the snoot 21 is tilted so that the light-shielding piece 30 on the snoot 21 rotates together, thus changing the relative shape relationship between the auxiliary light-transmitting hole 31 on the light-shielding piece 30 and the projection lens 221 so that when the relative position of the auxiliary light-transmitting hole 31 changes, the shape of the light spot 40 also changes, so as to achieve the purpose of changing the shape of the light spot 40, which is convenient for use.

In one example, as shown in FIGS. 9 and 10, during the execution of Step S003, if the auxiliary light-transmitting hole 31 is elliptical, then when the long axis of the auxiliary light-transmitting hole 31 is parallel to the horizontal plane, the shape of the light spot 40 projected from the emergent end 21b is round, and after the rotation angle of the snoot 21 is 90°, the light spot 40 is an elongated ellipse; and if the auxiliary light-transmitting hole 31 is elliptical, then when the long axis of the auxiliary light-transmitting hole 31 is perpendicular to the horizontal plane, the shape of the light spot 40 projected from the emergent end 21b is an elongated ellipse, and after the rotation angle of the snoot 21 is 90°, the light spot 40 is round. Specifically, by plugging the light-shielding piece 30 with the elliptical auxiliary light-transmitting hole 31 into the plug slot 213, and adjusting both the center of the auxiliary light-transmitting hole 31 and the center of the light-transmitting hole 2221 to be on the central axis of the snoot 21, the photographer can obtain the light spot 40 that switches between a circle and an ellipse by rotating the snoot 21 after the snoot 21 is tilted. The photographer can use it as needed without replacing the light-shielding piece 30, which is convenient for use.

The above is only optional examples of this application and is not intended to limit this application. For those of skill in the art, this application may have various changes and variations. Any modification, equivalent replacement, improvement, and the like made within the spirit and principles of this application shall be comprised in the claims of this application.

1. An auxiliary photographic equipment, characterized by comprising a light-emitting assembly, a snoot assembly and a light-shielding piece, wherein the light-emitting assembly is provided with a light-emitting area in which an illuminating lamp is mounted; the snoot assembly comprises a snoot and a lens module, the snoot is provided with an incident end and an emergent end, the incident end of the snoot is connected to the light-emitting assembly and covers the light-emitting area, the lens module is mounted in the snoot and located between the incident end and the emergent end, and the lens module is configured to organize light rays from the incident end and then emit the light rays through the emergent end to form a light spot; and the light-shielding piece is detachably plugged on the snoot, and the light-shielding piece is provided with at least one auxiliary light-transmitting hole for adjusting a shape of the light spot.

2. The auxiliary photographic equipment according to claim 1, wherein the light-shielding piece is in a shape of a long strip, a plurality of the auxiliary light-transmitting holes are provided, and each of the auxiliary light-transmitting holes extends along a length direction of the light-shielding piece.

3. The auxiliary photographic equipment according to claim 1, wherein the auxiliary light-transmitting holes are centrosymmetric.

4. The auxiliary photographic equipment according to claim 1, wherein the lens module comprises a projection lens and an optical lens module, the projection lens is mounted on the snoot and used to diffuse the light emitted from the incident end, the optical lens module is mounted in the snoot and located between the projection lens and the emergent end, the light-shielding piece is provided attaching to the projection lens and located on a side of the projection lens facing toward the emergent end, and the optical lens module is used to converge and shape the light passing through the auxiliary light-transmitting hole, and then the light is emitted from the emergent end.

5. The auxiliary photographic equipment according to claim 4, wherein the lens module further comprises a light-shielding ring which is provided attaching to the projection lens, is located between the projection lens and the light-shielding piece, and is provided with at least one light-transmitting hole for projection, and a cross section of the light-transmitting hole is greater than or equal to a cross section of the auxiliary light-transmitting hole.

6. The auxiliary photographic equipment according to claim 5, wherein the lens module comprises a condensing lens and a beam shaping lens set, in which the condensing lens is mounted on the snoot and provided close to the light-shielding ring, and the beam shaping lens set is mounted on the snoot and provided close to the emergent end.

7. The auxiliary photographic equipment according to claim 6, wherein the condensing lens comprises an annular mounting part and a condensing part, in which the annular mounting part is provided attaching to the periphery of the condensing part, the annular mounting part is mounted on the snoot, and the condensing part is located on a side of the annular mounting part facing toward the beam shaping lens set.

8. The auxiliary photographic equipment according to claim 7, wherein an annular washer is provided between the condensing part and the snoot.

9. The auxiliary photographic equipment according to claim 6, wherein the beam shaping lens set comprises a first shaping lens and a second shaping lens, in which the first shaping lens and the second shaping lens are mounted on the snoot side by side, and the second shaping lens is provided close to a side of the first shaping lens facing toward the emergent end.

10. The auxiliary photographic equipment according to claim 9, wherein the snoot assembly further comprises a protective lens, which is mounted on the snoot and located between the emergent end and the second shaping lens, and is used to prevent foreign matters from entering the snoot from the emergent end.

11. The auxiliary photographic equipment according to claim 6, wherein at least one annular anti-reflection piece is provided between the condensing lens and the beam shaping lens set to reflect light rays incident toward an inner wall of the snoot.

12. The auxiliary photographic equipment according to claim 11, wherein the inner wall of the snoot is provided with an annular slot, and the periphery of the annular anti-reflection piece is clamped in the annular slot.

13. The auxiliary photographic equipment according to claim 4, wherein the light-emitting assembly is provided with a socket, the light-emitting area is located at the end of the socket, and the snoot is sleeved with the socket.

14. The auxiliary photographic equipment according to claim 13, wherein the snoot comprises a light incident cylindrical sleeve, and a light projection cylindrical sleeve mounted at an end of the light incident cylindrical sleeve, in which the light incident cylindrical sleeve is sleeved with the socket, the incident end is located at an end of the light incident cylindrical sleeve away from the light projection cylindrical sleeve, the emergent end is located at an end of the light projection cylindrical sleeve away from the light incident cylindrical sleeve, the projection lens, the light-shielding piece and the optical lens module are all mounted on the light projection cylindrical sleeve.

15. The auxiliary photographic equipment according to claim 14, wherein the light incident cylindrical sleeve comprises a mounting cylindrical sleeve, one end of the mounting cylindrical sleeve is connected with the light projection cylindrical sleeve, and the other end of the mounting cylindrical sleeve is sleeved with the socket.

16. The auxiliary photographic equipment according to claim 15, wherein the light incident cylindrical sleeve further comprises a light transition cylindrical sleeve, which is mounted between the mounting cylindrical sleeve and the light projection cylindrical sleeve.

17. The auxiliary photographic equipment according to claim 5, wherein the snoot is provided with a plug slot that runs through opposite sides of the snoot, the plug slot is provided close to the light-shielding ring and is located at a side of the light-shielding ring facing toward the emergent end, and the light-shielding ring is plugged in the plug slot.

18. The auxiliary photographic equipment according to claim 17, wherein a side wall of the plug slot is provided with a positioning protrusion positioned with the light-shielding piece, and the light-shielding piece is provided with a positioning slot positioned with the side wall of the plug slot.

19. A method for using the auxiliary photographic equipment according to claim 1, characterized by comprising the following steps:
S001: providing a light-emitting assembly, a snoot assembly and a light-shielding piece, rotatably mounting the snoot on the light-emitting assembly, and plugging the light-shielding piece on the snoot;
S002: turning on an illuminating lamp located in the light-emitting area such that the light enters the snoot, and after organizing the light through the lens module and the auxiliary light-transmitting hole, emitting the light from the emergent end and forming a light spot; and
S003: tilting the snoot by a certain angle and allowing the emergent end to face toward the target, and/or rotating the snoot by 0° to 90° to adjust the shape of the light spot projected on the target.

20. The method for using the auxiliary photographic equipment according to claim 19, wherein during execution of step S003, if the auxiliary light-transmitting hole is elliptical, when a long axis of the auxiliary light-transmitting hole is parallel to a horizontal plane, a shape of the light spot projected from the emergent end is circular, and after rotation of the snoot by 90°, the light spot is elliptical, and if the auxiliary light-transmitting hole is elliptical, when the long axis of the auxiliary light-transmitting hole is perpendicular to the horizontal plane, the shape of the light spot projected from the emergent end is elliptical, and after rotation of the snoot by 90°, the light spot is circular.
